(19) United States
(12) Patent Application Publication
(10) Pub. No.: US 2015/0117069 A1
(43) Pub. Date: Apr. 30, 2015

(54) POWER SUPPLY APPARATUS AND METHOD OF CONTROLLING THE SAME

(71) Applicant: Samsung Electro-Mechanics Co. Ltd., Suwon-Si (KR)

(72) Inventors: Jae Kuk KIM, Daejeon-si (KR); Chong Eun Kim, Daejeon-si (KR)

(73) Assignee: Samsung Electro-Mechanics Co. Ltd.

(21) Appl. No.: 14/529,005

(22) Filed: Oct. 30, 2014

(30) Foreign Application Priority Data
Oct. 31, 2013 (KR) 10-2013-0131195

(51) Int. Cl. H02M 3/335

(52) U.S. Cl. CPC H02M 3/33538
USPC 363/21.09

(57) ABSTRACT

A power supply apparatus and a method of controlling the same. The power supply apparatus includes a DC/AC converting unit; a transformer; a AC/DC converting unit; and a loss compensating unit disposed before an inductor in a secondary side output stage of the transformer and compensating for power loss due to the inductor in a light load condition. The loss compensating unit is a circuit comprising a capacitor and a semiconductor switch element connected in series. The semiconductor switch element is turned off in a load condition greater than a light load and turned on in a light load condition according to a control instruction from an external control unit. The method comprises the method comprises supplying current to a load through an output stage of the AC/DC converting unit; detecting voltage across the load to determine whether the load is a light load; if the load is greater than the light load, supplying power to the load, with a semiconductor switch element of the loss compensating unit turned off; and if the load is the light load, supplying power to the load, with the semiconductor switch element of the loss compensating unit turned on.

### CROSS REFERENCE(S) TO RELATED APPLICATIONS

This application claims the foreign priority benefit under 35 U.S.C. Section 119 of Korean Patent Application Serial No. 10-2013-0131195, entitled “Power Supply Apparatus and Method of Controlling the Same” filed on Oct. 31, 2013, which is hereby incorporated by reference in its entirety into this application.

### BACKGROUND

1. Technical Field

The present disclosure relates to a power supply apparatus for supplying power to a server of a PC and the like and a method of controlling the same, and more particularly, to a power supply apparatus and a method of controlling the same capable of improving efficiency in a light load condition.

2. Description of the Related Art

In general, converters having output inductors are commonly used in server power supplies or PC power supplies that require high output current. Such converters, however, have a problem in that, in a light load condition, the portion of turn-off loss in a switch at the primary side or a synchronous rectifier at the secondary side and the portion of snubber loss occurring at the secondary side become larger due to the output inductor, thereby lowering efficiency. In other words, as can be seen from the characteristic waveforms shown in FIG. 1, according to existing converters, when switches are turned off, current flowing in the switch at the primary side and current flowing in the switch (synchronous rectifier) at the secondary side become larger due to the output inductors in a light load condition, such that the portions of the turn-off loss and the snubber loss become large. Therefore, efficiency is lowered.

### SUMMARY

An object of the present disclosure is to provide a power supply apparatus and a method of controlling the same capable of improving efficiency in a light load condition.

According to an exemplary embodiment, there is provided a power supply apparatus, including a DC/AC converting unit converting a DC voltage supplied from a DC voltage source into an AC voltage; a transformer receiving the AC voltage converted by the DC/AC converting unit to generate AC voltage having a different amplitude according to a turns ratio between primary and secondary windings thereof; a AC/DC converting unit converting the AC voltage at the secondary winding of the transformer into a DC voltage; and a loss compensating unit disposed before an inductor in a secondary side output stage of the transformer and compensating for power loss due to the inductor in a light load condition.

The loss compensating unit may be a circuit comprising a capacitor and a semiconductor switch element connected in series.

The semiconductor switch element may be a MOSFET.

The semiconductor switch element of the loss compensating unit may be turned off in a load condition greater than a light load and turned on in a light load condition according to a control instruction from an external control unit.

According to another exemplary embodiment, there is provided a method of controlling a power supply apparatus, wherein the power supply apparatus includes a DC/AC converting unit, a transformer, a AC/DC converting unit and a loss compensating unit, the method including the steps of (a) supplying current to a load through an output stage of the AC/DC converting unit; (b) detecting voltage across the load to determine whether the load is a light load; (c) if it is determined that the load is greater than the light load, supplying power to the load, with a semiconductor switch element of the loss compensating unit turned off; and (d) if it is determined that the load is the light load, supplying power to the load, with the semiconductor switch element of the loss compensating unit turned on.

The method may further include transmitting a control instruction to turn off the semiconductor switch element of the loss compensating unit from an external control unit to the semiconductor switch element of the loss compensating unit, if it is determined that the load is greater than the light load in step (c).

The method may further include transmitting a control instruction to turn on the semiconductor switch element of the loss compensating unit from the external control unit to the semiconductor switch element of the loss compensating unit, if it is determined that the load is the light load in step (d).

### BRIEF DESCRIPTION OF THE DRAWINGS

FIG. 1 is a graph showing the characteristics of current flowing in switches at primary and secondary sides in different operation modes of a conventional converter in a heavy load condition;

FIG. 2 is a circuit diagram of a power supply apparatus according to an exemplary embodiment of the present invention;

FIG. 3A is a circuit diagram of the power supply apparatus according to an exemplary embodiment operating in a heavy load condition;

FIG. 3B is a circuit diagram of the power supply apparatus according to an exemplary embodiment operating in a light load condition;

FIG. 4 is a graph showing the characteristics of current flowing in switches at primary and secondary sides in different operation modes of a power supply apparatus in a light load condition; and

FIG. 5 is a flowchart illustrating a method of controlling a power supply apparatus according to an exemplary embodiment of the present invention.

### DESCRIPTION OF THE PREFERRED EMBODIMENTS

Terms and words used in the present specification and claims are not to be construed as a general or dictionary meaning, but are to be construed as meaning and concepts meeting the technical ideas of the present invention based on a principle that the inventors can appropriately define the concepts of terms in order to describe their own inventions in the best mode.

Throughout the present specification, unless explicitly stated otherwise, “comprising” any components will be understood to imply the inclusion of other elements rather than the exclusion of any other elements. The terms “part,” “module,” “device” or the like used in the specification means a unit of processing at least one function or operation and may be implemented by hardware or software or a combination of hardware and software.

Hereinafter, exemplary embodiments of the present invention will be described in detail with reference to the accompanying drawings.

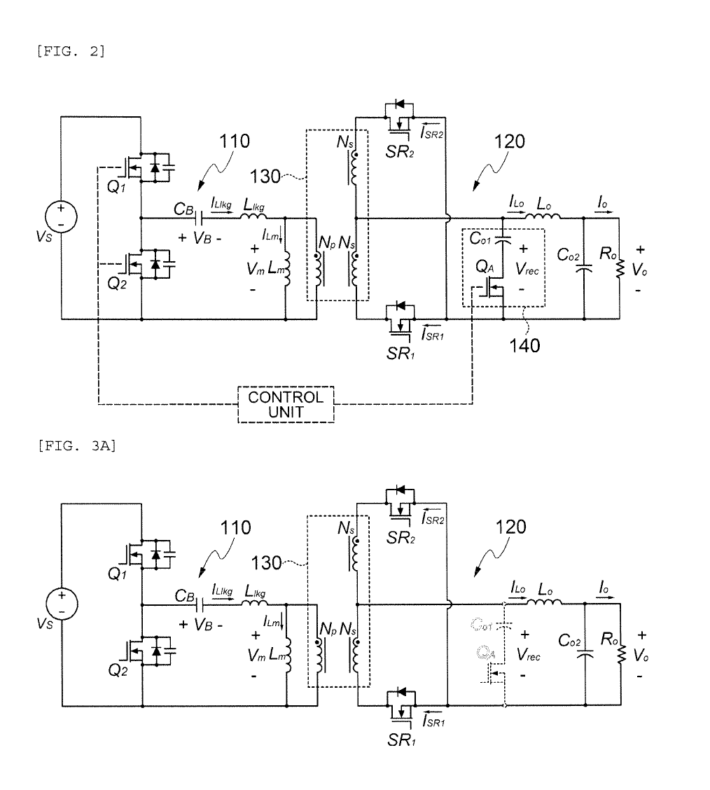

FIG. 2 is a circuit diagram of a power supply apparatus according to an exemplary embodiment of the present invention.

Referring to FIG. 2, the power supply apparatus according to the exemplary embodiment include a DC/AC converting unit 110, an AC/DC converting unit 120, a transformer 130, and a loss compensating unit 140.

The DC/AC converting unit 110 converts DC voltage supplied from a DC voltage source Vs into an AC voltage. As shown, the DC/AC converting unit 110 may be configured as an asymmetric half bridge structure in which two MOSFETs Q1 and Q2 are connected to each other in series, a capacitor and an inductor are connected to each other in series at the common connection node between the two MOSFETs Q1 and Q2.

The transformer 130 receives the AC voltage converted by the DC/AC converting unit 110 at the primary winding Np thereof so as to generate, at the secondary winding, an AC voltage having an amplitude different from that of the input voltage at the primary winding Np according to a turns ratio between primary and secondary windings thereof.

The AC/DC converting unit 120 converts the AC voltage at the secondary winding Ns of the transformer 130 into a DC voltage.

The loss compensating unit 140 is disposed before an inductor Lo at the secondary output stage of the transformer 130 and serves to compensate for power loss caused by the inductor Lo in a light load condition. The loss compensating unit 140 may comprise a capacitor Cₒ₁ and a semiconductor switch element Q_{A} connected to each other in series. The semiconductor switch element Q_{A} may be a MOSFET.

Hereinafter, a control method and an operation of the power supply apparatus thus configured according to an exemplary embodiment will be described.

FIG. 5 is a flowchart illustrating the processes of a method of controlling a power supply apparatus according to an exemplary embodiment of the present invention.

Referring to FIG. 5, the method of controlling the power supply apparatus, which includes the DC/AC converting unit 110, the transformer 130, the AC/DC converting unit 120 and the loss compensating unit 140, according to an exemplary embodiment of the present invention includes supplying current Io to a load Ro through the output stage of the AC/DC converting unit 120 (S501). Then, the method includes detecting the voltage Vo across the load Ro (S502) to determine whether the load is a light load (S503). The voltage Vo across the load Ro may be detected by using a separate voltage detecting sensor (not shown) or by feeding back the current Io flowing in the load from an external control unit to multiply the current by the load.

In the determining step S503, if the load is greater than a light load, power is supplied to the load Ro with the semiconductor switch element Q_{A} of the loss compensating unit 140 switched off (S505). Preferably, if the load is greater than a light load, the method may further include transmitting a control instruction to switch off the semiconductor switch element Q_{A} of the loss compensating unit 140 from an external control unit to the semiconductor switch element Q_{A} of the loss compensating unit 140 (S504).

In the determining step S503, if the load is a light load, power is supplied to the load Ro with the semiconductor switch element Q_{A} of the loss compensating unit 140 switched on (S507). Preferably, if the load is a light load, the method may further include transmitting a control instruction to switch on the semiconductor switch element Q_{A} of the loss compensating unit 140 from an external control unit to the semiconductor switch element Q_{A} of the loss compensating unit 140 (S506).

Hereinafter, more details on the method of controlling the power supply apparatus according to the present teachings will be described.

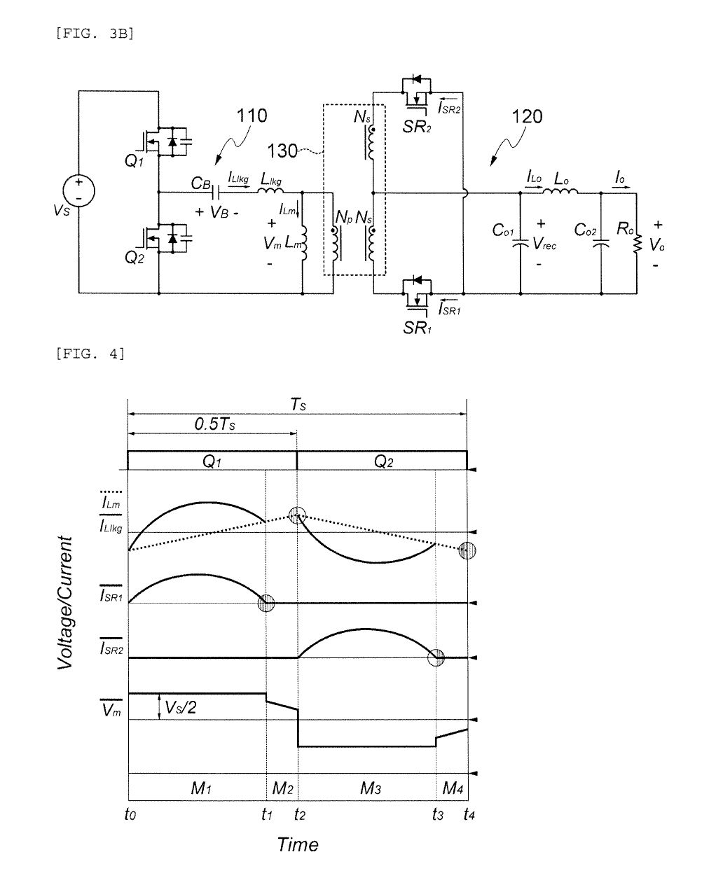

If the load is greater than the light load, since the portion of conduction loss is larger than the portions of turn-off loss or snubber loss of a semiconductor element, control is made according to a previously existing method, with the semiconductor switch element Q_{A} of the loss compensating unit 140 provided at the secondary side of the transformer 130 switched off, as shown in FIG. 3A. Accordingly, by virtue of the output inductor Lo that maintains a constant amount of current, the root mean square (RMS) current flowing the primary switches Q1 and Q2 of the transformer 130 and the RMS current flowing in the secondary switches SR₁ and SR₂ become smaller, such that efficiency may be increased when the load is greater than the light load.

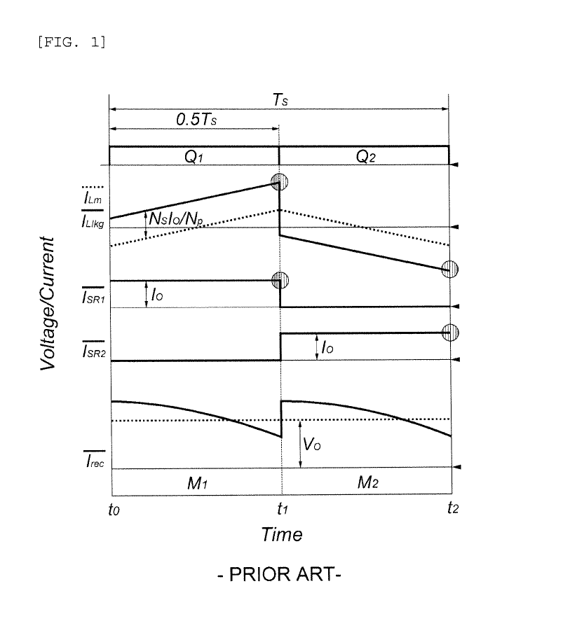

According to the previously existing control method, however, in the light load condition, due to the output inductor Lo, as described with reference to FIG. 1, the difference between the current Iₗₘ and I_{Llkg} flowing through the primary switches Q1 and Q2 and the current I_{SR1} and I_{SR2} flowing through the secondary switches SR1 and SR2 becomes larger when the switches are turned off, such that the portions of the turn-off loss and the snubber loss become larger, thereby lowering efficiency. In order to overcome this problem, according to the present invention, as shown in FIG. 3B, in the light load condition, the semiconductor switch element Q_{A} of the loss compensating unit 140 is switched on, such that a control scheme that has CLC filter comprising the capacitor Cₒ₁, the output inductor Lo, and the output capacitor Cₒ₂ of the loss compensating unit 140 is applied instead of the previously existing control scheme that has the output inductor Lₒ₁ and the output inductor Cₒ₂.

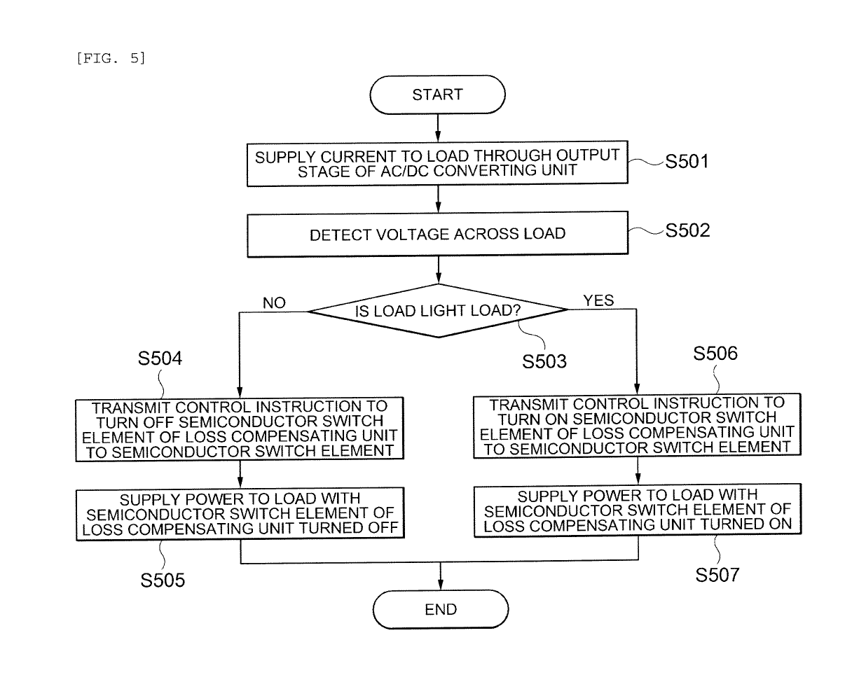

By applying the CLC filter, it operates like an existing half-bridge LLC converter, such that the current I_{Lm} and I_{Llkg} flowing through the primary switch is reduced and the current flowing the secondary switches SR1 and SR2 become zero when the switches are turned off, as shown in FIG. 4, thereby reducing the turn-off loss occurring in the primary and secondary sides of the transformer 130. Further, by virtue of the CLC filter, the voltage across the secondary switches SR1 and SR2 is clamped to an output voltage, such that the snubber loss may also be reduced. As such, if the power supply apparatus according to the present disclosure is employed as power supply apparatuses of a server or computer, in the light load condition, the portion of the conduction loss due to the RMS current in the primary and secondary sides of the transformer 130 becomes substantially reduced while the portions of the turn-off loss or the snubber loss become larger, such that efficiency may be improved not only in the heavy load condition but also under the light load condition.

As described above, the power supply apparatus according to the present disclosure includes a CLC filter by disposing a capacitor before an output inductor at the secondary side of a transformer, such that turn-off loss may be reduced occurring at the primary and secondary sides of the transformer when the switches are turned off, thereby increasing efficiency in a light load condition.

Although the exemplary embodiments of the present invention have been disclosed for illustrative purposes, the present invention is not limited thereto, but those skilled in the art will appreciate that various modifications, additions and substitutions are possible, without departing from the scope and spirit of the invention as disclosed in the accompanying claims. Therefore, the true scope of the present invention to be protected should be defined only by the appended claims and it is apparent to those skilled in the art that technical ideas equivalent thereto are within the scope of the present invention.

What is claimed is:

1. A power supply apparatus, comprising:
a DC/AC converting unit converting a DC voltage supplied from a DC voltage source into an AC voltage;
a transformer receiving the AC voltage converted by the DC/AC converting unit to generate an AC voltage having a different amplitude according to a turns ratio between primary and secondary windings thereof;
a AC/DC converting unit converting the AC voltage at the secondary winding of the transformer into a DC voltage; and
a loss compensating unit disposed before an inductor in a secondary side output stage of the transformer and compensating for power loss due to the inductor in a light load condition.

2. The power supply apparatus according to claim 1, wherein the loss compensating unit is a circuit comprising a capacitor and a semiconductor switch element connected in series.

3. The power supply apparatus according to claim 2, wherein the semiconductor switch element is a metal-oxide semiconductor field effect transistor (MOSFET).

4. The power supply apparatus according to claim 2, wherein the semiconductor switch element of the loss compensating unit is turned off in a load condition greater than light load and turned on in a light load condition according to a control instruction from an external control unit.

5. A method of controlling a power supply apparatus, wherein the power supply apparatus includes a DC/AC converting unit, a transformer, a AC/DC converting unit and a loss compensating unit, the method comprising the steps of:
(a) supplying current to a load through an output stage of the AC/DC converting unit;
(b) detecting voltage across the load to determine whether the load is a light load;
(c) if it is determined that the load is greater than the light load, supplying power to the load, with a semiconductor switch element of the loss compensating unit turned off; and
(d) if it is determined that the load is the light load, supplying power to the load, with the semiconductor switch element of the loss compensating unit turned on.

6. The method according to claim 5, further comprising transmitting a control instruction to turn off the semiconductor switch element of the loss compensating unit from an external control unit to the semiconductor switch element of the loss compensating unit, if it is determined that the load is greater than the light load in step (c).

7. The method according to claim 5, further comprising transmitting a control instruction to turn on the semiconductor switch element of the loss compensating unit from an external control unit to the semiconductor switch element of the loss compensating unit, if it is determined that the load is the light load in step (d).
